(19) United States
(12) Patent Application Publication
(10) Pub. No.: US 2025/0039780 A1
(43) Pub. Date: Jan. 30, 2025

(54) ELECTRONIC DEVICE SUPPORTING NON-TERRESTRIAL NETWORK COMMUNICATION AND METHOD FOR OPERATING THE SAME

(71) Applicant: Samsung Electronics Co., Ltd., Suwon-si (KR)

(72) Inventors: Namkyeom KIM, Suwon-si (KR); Seungbeom SHIN, Suwon-si (KR)

(21) Appl. No.: 18/768,706

(22) Filed: Jul. 10, 2024

Related U.S. Application Data
(63) Continuation of application No. PCT/KR2024/009593, filed on Jul. 5, 2024.

(30) Foreign Application Priority Data
Jul. 26, 2023 (KR) 10-2023-0097608
Aug. 31, 2023 (KR) 10-2023-0115774

(51) Int. Cl. H04W 48/20; H04W 8/18; H04W 48/16; H04W 88/06

(52) U.S. Cl. CPC H04W 48/20; H04W 8/18; H04W 48/16; H04W 88/06

(57) ABSTRACT

One or more non-transitory computer-readable storage media storing one or more computer programs including computer-executable instructions that, when executed one or more processors of an electronic device individually or collectively, cause the electronic device to perform at least one operation are provided. The at least one operation include performing, by the electronic device, a first scan for a first part of a plurality of frequencies for non-terrestrial networks (NTN) communication by using a first radio frequency (RF) path of the electronic device corresponding to a first subscriber identity module (SIM) capable of being used by the one or more processors, while the first scan is being performed, performing, by the electronic device, a second scan for a second part of the plurality of frequencies for the NTN communication by using a second RF path of the electronic device corresponding to a second SIM capable of being used by the one or more processors, the second part at least including frequencies different from the first part, and performing, by the electronic device using the first SIM, at least one operation for accessing a cell identified by the second scan.

### CROSS-REFERENCE TO RELATED APPLICATION(S)

This application is a continuation application, claiming priority under § 365 (c), of an International application No. PCT/KR2024/009593, filed on Jul. 5, 2024, which is based on and claims the benefit of a Korean patent application number 10-2023-0097608, filed on Jul. 26, 2023, in the Korean Intellectual Property Office, and of a Korean patent application number 10-2023-0115774, filed on Aug. 31, 2023, in the Korean Intellectual Property Office, the disclosure of each of which is incorporated by reference herein in its entirety.

### TECHNICAL FIELD

The disclosure relates to an electronic device supporting non-terrestrial network communication and a method for operating the same.

### BACKGROUND ART

Recently, electronic devices supporting non-terrestrial network communication (e.g., satellite communication) are being actively introduced. As an example, an electronic device may communicate with a satellite of a satellite communication company by using the frequency and communication scheme of the company. As an example, an electronic device may communicate with a satellite using a long-term evolution (LTE) standard cellular frequency based on the LTE standard (or fifth generation (5G) standard). As an example, an electronic device may communicate with a satellite based on the 5G non-terrestrial networks (NTN) standard. In a wireless communication system, an electronic device (e.g., user equipment (UE)) may access a wireless communication network and use a voice communication or data communication service in a fixed position or on the move. To provide a communication service to an electronic device, an appropriate authentication process is required. A universal integrated circuit card (UICC) is inserted into the electronic device, and authentication is performed between the electronic device and the server of the mobile network operator (MNO) through a universal subscriber identity module (USIM) installed in the UICC. UICC may be called subscriber identity module (SIM) in the case of global system for mobile communications (GSM) and USIM in the case of wideband code division multiple access (WCDMA), long term evolution (LTE), and new radio (NR). The USIM card or SIM card may be provided as a standalone UICC or may be embedded (e.g., embedded SIM, eSIM) in the electronic device or may be integrated into at least one chip included in the electronic device (e.g., integrated SIM, iSIM).

The above information is presented as background information only to assist with an understanding of the disclosure. No determination has been made, and no assertion is made, as to whether any of the above might be applicable as prior art with regard to the disclosure.

### DISCLOSURE OF INVENTION

Aspects of the disclosure are to address at least the above-mentioned problems and/or disadvantages and to provide at least the advantages described below. Accordingly, an aspect of the disclosure is to provide an electronic device supporting non-terrestrial network communication and a method for operating the same.

Additional aspects will be set forth in part in the description which follows and, in part, will be apparent from the description, or may be learned by practice of the presented embodiments.

### Solution to Problems

In accordance with an aspect of the disclosure, one or more non-transitory computer-readable storage media storing one or more computer programs including computer-executable instructions that, when executed by one or more processors of an electronic device individually or collectively, cause the electronic device to perform at least one operation are provided. The at least one operation include performing, by the electronic device, a first scan for a first part of a plurality of frequencies for non-terrestrial networks (NTN) communication by using a first radio frequency (RF) path of the electronic device corresponding to a first subscriber identity module (SIM) capable of being used by the one or more processors. The at least one operation may comprise, while the first scan is being performed, performing, by the electronic device, a second scan for a second part of the plurality of frequencies for the NTN communication by using a second RF path of the electronic device corresponding to a second SIM capable of being used by the one or more processors, the second part at least including frequencies different from the first part. The at least one operation may comprise performing, by the electronic device using the first SIM, at least one operation for accessing a cell identified by the second scan.

In accordance with another aspect of the disclosure, an electronic device is provided. The electronic device includes memory storing one or more computer programs, and one or more processors communicatively coupled to the memory, wherein the one or more computer programs include computer-executable instructions that, when executed by the one or more processors individually or collectively, cause the electronic device to perform a first scan for a first part of a plurality of frequencies for non-terrestrial networks (NTN) communication by using a first radio frequency (RF) path of the electronic device corresponding to a first subscriber identity module (SIM) capable of being used by the one or more processors, while the first scan is being performed, perform a second scan for a second part of the plurality of frequencies for the NTN communication by using a second RF path of the electronic device corresponding to a second SIM capable of being used by the one or more processors, the second part at least including frequencies different from the first part, and perform, by using the first SIM, at least one operation for accessing a cell identified by the second scan.

In accordance with another aspect of the disclosure, a method performed by an electronic device is provided. The method includes performing, by the electronic device, a first scan for a first part of a plurality of frequencies for non-terrestrial networks (NTN) communication by using a first radio frequency (RF) path of the electronic device corresponding to a first subscriber identity module (SIM) capable of being used one or more processors of the electronic device, while the first scan is being performed, performing a second scan for a second part of the plurality of frequencies for the NTN communication by using a second RF path of the electronic device corresponding to a second SIM capable of being used by the one or more processors, the second part at least including frequencies different from the first part, and performing, by the electronic device using the first SIM, at least one operation for accessing a cell identified by the second scan.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1A is a block diagram illustrating an electronic device in a network environment according to an embodiment of the disclosure;

FIG. 1B is a view illustrating a network environment including an electronic device according to an embodiment of the disclosure;

FIG. 2 is a view illustrating an electronic device and a long-range communication network environment according to an embodiment of the disclosure;

FIG. 3 is a view illustrating access to an electronic device according to an embodiment of the disclosure;

FIG. 4 is a view illustrating a non-terrestrial network system according to an embodiment of the disclosure;

FIG. 5A is a flowchart illustrating an operation method of an electronic device according to an embodiment of the disclosure;

FIG. 5B is a view illustrating an electronic device according to an embodiment of the disclosure;

FIG. 5C is a flowchart illustrating an operation method of an electronic device according to an embodiment of the disclosure;

FIG. 6A is a view illustrating a frequency scan according to an embodiment of the disclosure;

FIG. 6B is a view illustrating a frequency scan according to an embodiment of the disclosure;

FIG. 6C is a view illustrating a frequency scan according to an embodiment of the disclosure;

FIG. 7A is a flowchart illustrating an operation method of an electronic device according to an embodiment of the disclosure;

FIG. 7B is a view illustrating access according to an embodiment of the disclosure;

FIG. 7C is a flowchart illustrating an operation method of an electronic device according to an embodiment of the disclosure;

FIG. 7D is a view illustrating access according to an embodiment of the disclosure;

FIG. 8A is a flowchart illustrating an operation method of an electronic device according to an embodiment of the disclosure;

FIG. 8B is a view illustrating access according to an embodiment of the disclosure;

FIG. 9 is a flowchart illustrating a method for operating an electronic device according to an embodiment of the disclosure;

FIG. 10 is a flowchart illustrating an operation method of an electronic device according to an embodiment of the disclosure; and

FIG. 11 is a flowchart illustrating an operation method of an electronic device according to an embodiment of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

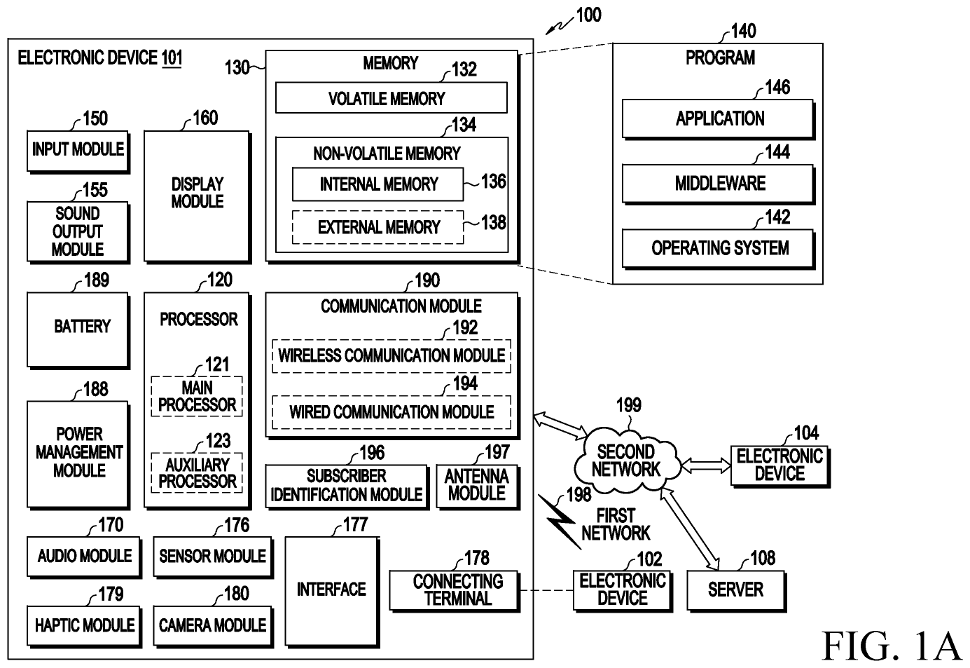

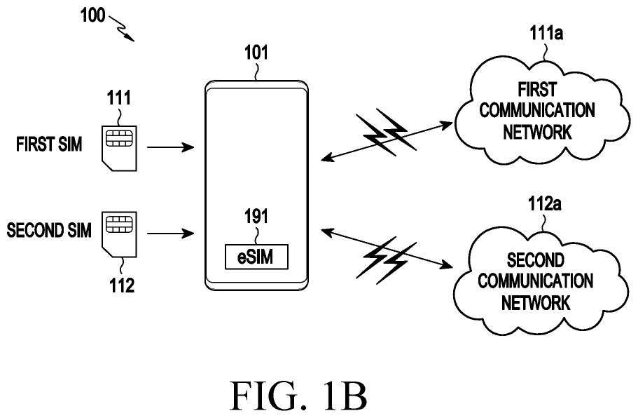

FIG. 1A is a block diagram illustrating an electronic device in a network environment according to an embodiment of the disclosure.

Referring to FIG. 1A, an electronic device 101 in a network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices (e.g., external electronic devices 102 and 104 and the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

FIG. 1B is a view illustrating a network environment including an electronic device according to an embodiment of the disclosure.

Referring to FIG. 1B, according to various embodiments of the disclosure, a network environment 100 may include an electronic device 101, a first communication network 111a, a second communication network 112a, or a third communication network (not shown).

According to various embodiments, the electronic device 101 may operate in a dual SIM dual active (DSDA) mode supporting a plurality of SIMs in one device, but is not limited thereto. For example, the electronic device 101 may be equipped with two SIMs, e.g., a first SIM 111 and/or a second SIM 112. The first SIM 111 and the second SIM 112 may be removable SIMs (rSIMs). The rSIM may be an SIM detachable from a slot provided in the electronic device 101 and its form/specifications are not limited to specific ones. For example, the electronic device 101 may be equipped with two SIM cards to support the two SIMs. According to an embodiment, for convenience of description, the first SIM 111 and the second SIM 112 are shown as SIM cards, but are not limited thereto. The electronic device 101 may include an embedded SIM (eSIM) 191. For example, the electronic device 101 may be implemented to include only the eSIM 191, and the eSIM 191 may activate a plurality of profiles. In this case, a dual SIM-based operation based on the plurality of profiles may be performed. The electronic device 101 may be implemented to include the eSIM 191 and a slot for mounting one or more SIMs. In this case, the electronic device 101 may perform the dual SIM-based operation based on information stored in an rSIM inserted (or connected) in the slot and the profile activated by the eSIM 191. The electronic device 101 may perform dual SIM-based operations based on two rSIMs, and the combination is not limited. For example, at least one of the first SIM 111 or the second SIM 112 may be replaced with an eSIM or an integrated SIM (iSIM). In this case, at least part of the information stored in the rSIM may be replaced by information about the profile activated by the eSIM. Hereinafter, for convenience of description, the SIM card will be referred to as an SIM. As illustrated in FIG. 1B, two SIM cards, the first SIM 111 and the second SIM 112, may be mounted in the electronic device 101. The electronic device 101 may include a first slot (not shown) and a second slot (not shown), which are structures, to receive the first SIM 111 and the second SIM 112, respectively.

For example, the first SIM 111 is an SIM which has subscription to the mobile network operator of the first communication network 111a. The electronic device 101 may access the first communication network 111a using the first SIM 111 to receive the wireless communication service. The second SIM 112 is an SIM which has subscription to the mobile network operator of the second communication network 112a. The electronic device 101 may access the second communication network 112a using the second SIM 112 to receive the wireless communication service. The first communication network 111a and the second communication network 112a may be provided by the same communication carrier or may be provided by different communication carriers, separately. When the first communication network 111a and the second communication network 112a are provided by the same mobile network operator, the first communication network 111a and the second communication network 112a may mean the same network. Or, different operators may share a communication network. For example, a first mobile network operator may use the first communication network 111a, and a second mobile network operator may be configured to also use the second communication network 112a. According to an embodiment, although not shown, one of ordinary skill in the art will easily understand that the electronic device 101 may further include at least one additional SIM, and the number or type of SIMs is not limited.

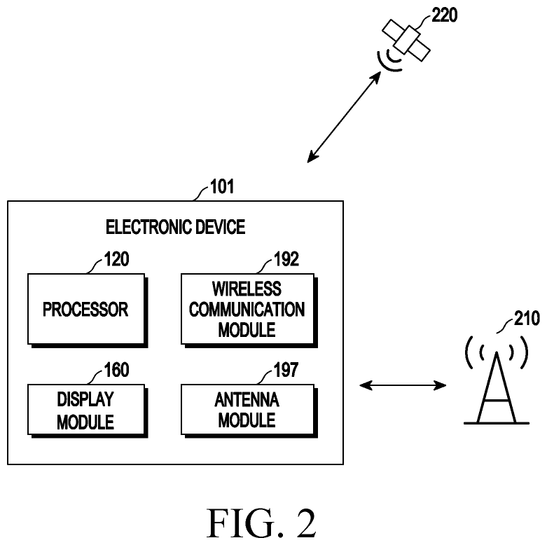

FIG. 2 is a view illustrating an electronic device and a long-range communication network environment according to an embodiment of the disclosure.

Referring to FIG. 2, an electronic device 101 may transmit and/or receive data through a terrestrial network and/or a non-terrestrial network. The electronic device 101 may have the same as the configuration of the electronic device 101 illustrated in FIG. 1A or may include the configuration of the electronic device 101 illustrated in FIG. 1B.

The terrestrial network may refer to a network capable of providing data communication through a terrestrial wireless communication device 210. For example, the terrestrial wireless communication device 210 may include a base station positioned on the ground (e.g., fixed to the ground). The terrestrial wireless communication device 210 may support at least one of various communication schemes supportable by the electronic device 101. For example, the terrestrial wireless communication device 210 may include an eNodeB (e.g., an LTE-based base station) or a gNodeB (e.g., a 5G (or NR)-based base station), but is not limited thereto.

The non-terrestrial network may refer to a network capable of providing data communication through at least one non-terrestrial wireless communication device 220. For example, the non-terrestrial wireless communication device 220 may include at least one of various communication devices such as a base station and a repeater that are not positioned on the ground. For example, the non-terrestrial wireless communication device 220 may include a satellite and/or an unmanned aerial vehicle, but is not limited thereto. For example, the satellite may include a low-earth orbit (LEO) satellite, a medium-earth orbit (MEO) satellite, a geostationary earth orbit (GEO) satellite, and/or a high elliptical orbit (HEO) satellite. For example, the satellite may include an orbiting satellite and/or a geostationary satellite.

The non-terrestrial wireless communication device 220 may support at least one of various wireless communication schemes. For example, the non-terrestrial wireless communication device 220 may support a non-terrestrial network (NR NTN) defined by 3rd generation partnership project (3GPP). Alternatively, the non-terrestrial wireless communication device 220 may support at least one of communication schemes based on various communication standards such as LTE, global system for mobile communications (GSM), or code-division multiple access (CDMA), but is not limited thereto.

The terrestrial network and the non-terrestrial network may be networks independent of each other. Alternatively, the terrestrial network and the non-terrestrial network may be included in at least one network (e.g., networks provided by the same operator) associated with each other.

When communication with the terrestrial network is not possible or is not seamless, the electronic device 101 may perform wireless communication through the non-terrestrial network. Alternatively, the electronic device 101 may perform wireless communication through the non-terrestrial network regardless of the communication state with the terrestrial network.

According to an embodiment, the electronic device 101 may include a processor 120, a display module 160 (e.g., a display), a wireless communication module 192 (e.g., a communication circuit), and/or an antenna module 197. For example, the processor 120 may be operatively, functionally, and/or electrically connected to the display module 160, the wireless communication module 192, and/or the antenna module 197.

The processor 120 may execute, e.g., instructions (e.g., the program 140 of FIG. 1A) at least temporarily stored in memory (e.g., the memory 130 of FIG. 1A) to control at least one other component (e.g., a hardware or software component) of the electronic device 101 connected to the processor 120, and may perform various data processing or computation. According to an embodiment, the processor 120 may control overall operations related to terrestrial network communication and/or non-terrestrial network communication. For example, the processor 120 may include a communication processor (e.g., the auxiliary processor 123 of FIG. 1A) related to terrestrial network communication and/or non-terrestrial network communication.

The display module 160 may visually provide information to the outside (e.g., a user) of the electronic device 101.

According to an embodiment, the display module 160 may display a user interface (UI) indicating information related to a terrestrial network and/or a non-terrestrial network. For example, the UI indicating information related to the terrestrial network and/or the non-terrestrial network may include at least one of UIs indicating information related to the type of network (e.g., cellular communication (third generation (3G), fourth generation (4G), or fifth generation (5G)), short-range communication (e.g., Bluetooth™ (BT), or wireless fidelity (Wi-Fi)), or satellite communication), the type of network service provider (e.g., satellite communication service provider (Iridium), emergency service provider (ESP)), the strength of the network signal (e.g., signal strength bars, received signal strength indicator (RSSI), or reference signal received power (RSRP)), the direction of the communication device (satellite) included in the network (e.g., the orientation, the elevation angle, or the azimuth angle), presence information, and/or the network communication state (e.g., idle, transmit, or receive).

According to an embodiment, the display module 160 may display a user interface (UI) indicating the service related to the terrestrial network and/or the non-terrestrial network.

According to an embodiment, the service related to the terrestrial network and/or the non-terrestrial network may include at least one of, e.g., an emergency message transmission service, a messaging service, a voice call, a video call, a data communication service, a location-related service, and/or a service related to an indicator.

According to an embodiment, the emergency message transmission service may include, but is not limited to, at least one of an SOS service state information providing service (e.g., display whether it is possible to provide an SOS service), a government office information providing service, an emergency contact information providing service, a text template providing service that minimizes the user's text entry, or a questionnaires service (e.g., a service for providing questionnaires, such as accident type, injured area, or medical information (e.g., age, gender, disease information, or medication information)) for quickly letting the emergency situation know.

According to an embodiment, the messaging service may include at least one of a short message service (SMS), a multimedia messaging service (MMS), or a rich communication suite (RCS) message, but is not limited thereto.

According to an embodiment, the data communication service may include a service through various applications (e.g., web browsers) that provide data communication.

According to an embodiment, the location-related service may include, but is not limited to, at least one of longitude/latitude coordinates, location-related map information about the non-terrestrial communication device 220, navigation, or a street view.

According to an embodiment, the UI example is not limited to the above-mentioned example, and may be provided through another output device (e.g., the sound output module 155 of FIG. 1A).

According to an embodiment, the wireless communication module 192 may support various types of wireless communication bands supported by the electronic device 101. For example, the wireless communication band supported by the electronic device 101 may include a short-range wireless communication band (e.g., BT or Wi-Fi), a terrestrial network (e.g., cellular network) communication band, and/or a non-terrestrial network band, but is not limited thereto.

According to an embodiment, the electronic device 101 may support a frequency band (e.g., n255, or n256) related to non-terrestrial network wireless communication. The electronic device 101 may perform non-terrestrial network wireless communication using a frequency band related to non-terrestrial network wireless communication, but is not limited thereto. For example, the electronic device 101 may perform non-terrestrial network wireless communication using at least a portion of the frequency band related to terrestrial network wireless communication.

According to an embodiment, the antenna module 197 may transmit or receive a signal or power to or from the outside (e.g., the external electronic device).

According to an embodiment, the electronic device 101 may perform wireless communication with the non-terrestrial network using at least one antenna among the plurality of antennas included in the antenna module 197. At least one antenna supporting non-terrestrial wireless communication may include a dedicated antenna and/or a multi-use antenna. The dedicated antenna may include an antenna supporting the non-terrestrial network. The multi-use antenna may include an antenna that supports different types of networks and non-terrestrial networks together. For example, the electronic device 101 may communicate with at least one satellite (e.g., a GNSS satellite or a satellite for emergency message service) using at least one non-terrestrial network-dedicated antenna. For example, the multi-use antenna may include an antenna supporting a short-range communication network (e.g., a Bluetooth™ network or a Wi-Fi network) and/or a terrestrial network (e.g., a long term evolution (LTE) network). The electronic device 101 may support a non-terrestrial network using a plurality of antennas among antennas supporting the terrestrial network.

Hereinafter, in the disclosure, a satellite is mainly mentioned as the non-terrestrial wireless communication device 220, and even if it is mentioned that the satellite provides wireless communication using a specific radio access technology (RAT) (e.g., LTE) or a specific function (e.g., a base station), this is merely an example, and the type thereof is not limited.

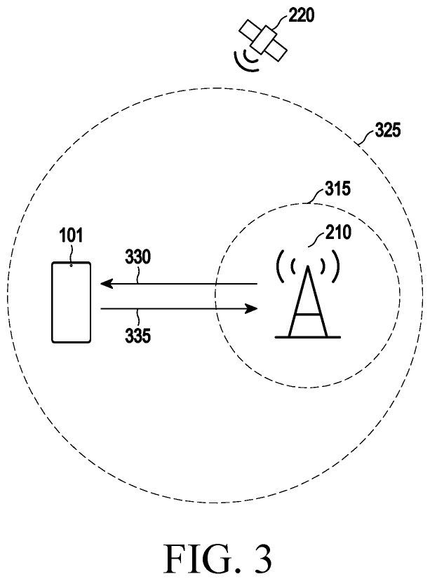

FIG. 3 is a view illustrating access to an electronic device according to an embodiment of the disclosure.

Referring to FIG. 3, according to an embodiment, an electronic device 101 may be positioned within coverage 315 (hereinafter, referred to as the terrestrial wireless communication coverage 315) of a terrestrial wireless communication device 210 and/or coverage 325 (hereinafter, referred to as the non-terrestrial wireless communication coverage 325) of a non-terrestrial wireless communication device 220. The non-terrestrial wireless communication coverage 325 may be relatively larger (e.g., 50 times larger) than the terrestrial wireless communication coverage 315. For example, the non-terrestrial wireless communication coverage 325 may cover an area not covered by the terrestrial wireless communication coverage 315 of the terrestrial wireless communication device 210, and accordingly, the electronic device 101 may perform communication even in an area where terrestrial wireless communication is not supported.

According to an embodiment, the electronic device 101 may perform a cell scan within the terrestrial wireless communication coverage 315 and/or the non-terrestrial wireless communication coverage 325. As a result of performing the cell scan, the electronic device 101 may identify a cell provided by the terrestrial wireless communication device 210 and/or a cell provided by the non-terrestrial wireless communication device 220. When there is a cell that meets the cell selection criteria, the electronic device 101 may perform at least some of operations for connecting to a network (e.g., a non-terrestrial network and/or a terrestrial network). Here, the connection to the network may include, e.g., at least some of a preceding operation (e.g., camping-on, or connection procedure (e.g., random connection (random access (RA)) procedure)) for registration to the network and/or a registration operation (e.g., attach, or registration)) to the network, but is not limited thereto. When disconnection from the network is required (e.g., moving to another network), the electronic device 101 may perform at least some of the disconnect operations. The operation for disconnecting from the network may include at least some of a detach from the network, release of connection, and/or radio link failure (RLF) declaration, and is not limited to the listed operations.

According to an embodiment, the electronic device 101 may perform at least some of cell scan, disconnection from the network, and/or connection to the network according to movement 330 or 335.

According to an embodiment, when the electronic device 101 is positioned within the terrestrial wireless communication coverage 315 included in the non-terrestrial wireless communication coverage 325 or is positioned in the boundary area of the terrestrial wireless communication coverage 315, the electronic device 101 may connect to the terrestrial network and/or the non-terrestrial network based on the policy (e.g., priority policy) of the electronic device 101.

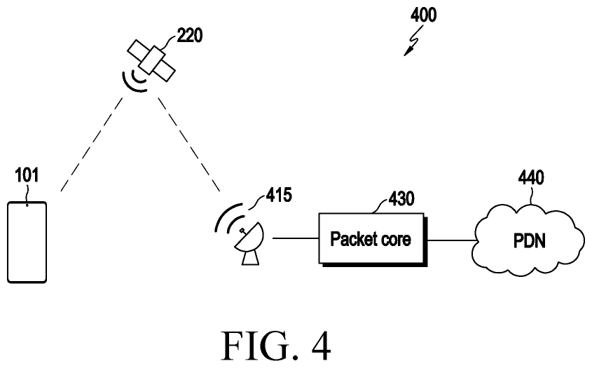

FIG. 4 is a view illustrating a non-terrestrial network system according to an embodiment of the disclosure.

Referring to FIG. 4, a non-terrestrial network system 400 may include a non-terrestrial wireless communication device 220, at least one radio unit 415, at least one packet core 430, and/or a packet data network (PDN) 440.

According to an embodiment, the non-terrestrial network system 400 may be implemented, e.g., in a regenerative scheme. When implemented in a regenerative scheme, the at least one non-terrestrial wireless communication device 220 may include a base station (e.g., eNode B). The non-terrestrial network system 400 may be implemented, e.g., in a bent-pipe scheme. The bent-pipe scheme may include a passive relay scheme that performs frequency conversion and power amplification on the received signal. When the non-terrestrial network system 400 is implemented in a bent-pipe scheme, the at least one non-terrestrial wireless communication device 220 may include a relay that converts (e.g., amplifies) and transmits a signal. The implementation method of the non-terrestrial network system 400 and the role of the non-terrestrial wireless communication device 220 described in FIG. 4 are merely examples, and are not limited thereto.

According to an embodiment, the non-terrestrial wireless communication device 220 may include at least one satellite. The non-terrestrial wireless communication device 220 may communicate with, e.g., the electronic device 101 using a terrestrial network (e.g., a cellular network) band and/or a non-terrestrial network band. The terrestrial network band may be, e.g., an operating band supported by long term evolution (LTE) and/or new radio (NR), but is not limited thereto. The non-terrestrial network band may include a band (e.g., n255 and/or n256 bands) defined by 3GPP, but is not limited thereto.

According to an embodiment, the at least one radio unit 415 may receive a signal of the non-terrestrial wireless communication device 220 and transmit the signal to the packet core 430. The radio unit 415 and the non-terrestrial wireless communication device 220 may perform communication using, e.g., a non-terrestrial network band. The non-terrestrial network band may be different from the terrestrial network band, but may be set to be the same in some cases.

According to an embodiment, the at least one packet core 430 may transmit and receive data associated with the electronic device 101 using the radio unit 415. Accordingly, the packet core 430 may process the data associated with the electronic device 101 and transmit the processed data to a packet data network (PDN) 440 (e.g., the Internet). The packet core 415 may include, e.g., at least some of an evolved packet core (EPC) and/or a 5G core (5GC), but is not limited thereto. The packet core 430 may include a packet core associated with the operator of the non-terrestrial wireless communication device 220 and/or a packet core associated with the mobile network operator (MNO). The packet core 430 may be additionally connected to a public switched telephone network (PSTN) (not shown) to transmit and receive data associated with the electronic device 101.

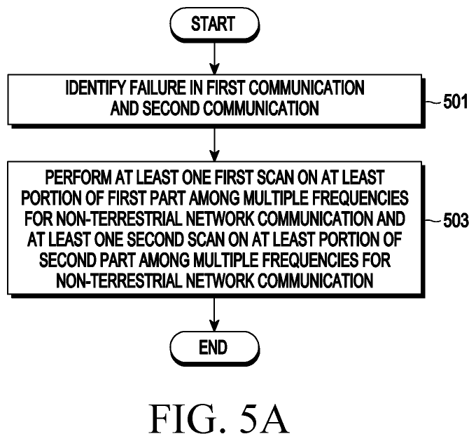

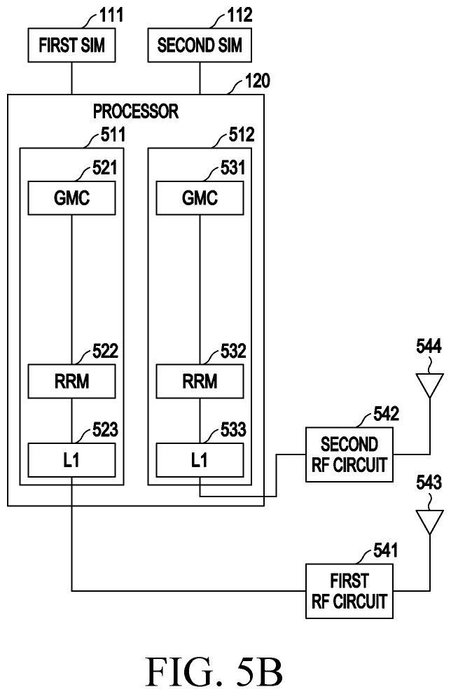

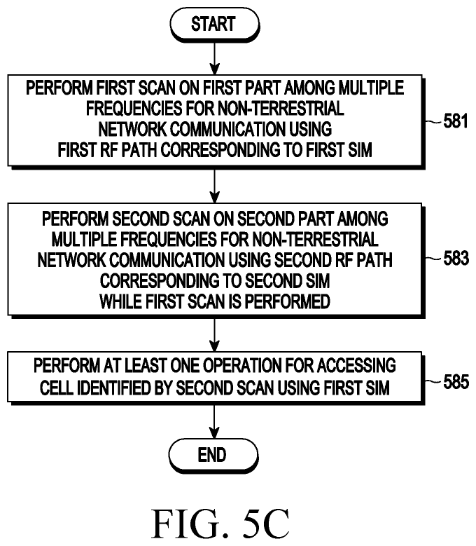

FIG. 5A is a flowchart illustrating an operation method of an electronic device according to an embodiment of the disclosure. The embodiment of FIG. 5A is described with reference to FIG. 5B. FIG. 5B is a view illustrating an electronic device according to an embodiment of the disclosure.

Referring to FIGS. 5A and 5B together, according to an embodiment, in operation 501, an electronic device 101 (e.g., processor 120) may identify a failure in first communication corresponding to a first protocol stack 511 and a failure in second communication corresponding to a second protocol stack 512. For example, the electronic device 101 may perform the first communication corresponding to the first protocol stack 511 using information associated with a first SIM 111. For example, the electronic device 101 may perform the second communication corresponding to the second protocol stack 512 using information associated with a second SIM 112. For example, the information associated with the first SIM 111 and/or the second SIM 112 may be replaced with information stored in the eSIM 191 (e.g., a profile activated based on the eSIM 191, but not limited thereto), but is not limited thereto. Thereafter, the electronic device 101 may identify a failure to perform the first communication and a failure to perform the second communication. For example, the electronic device 101 may identify a failure based on out-of-coverage, entry into a shadow area, and/or a weak electric field, but the cause of the failure is not limited. As described above, the electronic device 101 may fail in both the first communication corresponding to the first protocol stack 511 using the information associated with the first SIM 111 and the second communication corresponding to the second protocol stack 512 using the information associated with the second SIM 112. For convenience of description, the failure in the first communication corresponding to the first protocol stack 511 using the information associated with the first SIM 111 may be referred to as a failure in communication associated with the first SIM 111, and the failure in the second communication corresponding to the second protocol stack 512 may be referred to as a failure in communication associated with the second SIM 112. Meanwhile, FIG. 5B illustrates that the processor 120 includes the protocol stacks 511 and 512, but this is merely an example, which may mean that the processor 120 (e.g., a communication processor) may perform at least one instruction using the protocol stacks 511 and 512, but is not limited thereto.

The first protocol stack 511 corresponding to the first SIM 111 (or corresponding to the slot corresponding to the first SIM 111 or corresponding to the first RF path) may include a global mode control (GMC) layer 521, a radio resource management (RRM) layer 522, and/or an L1 layer 523, but this is an example, and at least one layer may be named as another layer (or by another term), and at least one layer may be omitted, and/or at least one additional layer may be included in the first protocol stack 511. One of ordinary skill in the art would appreciate that at least part of the expression “corresponds to the slot,” the expression “corresponds to the SIM (or activated profile) inserted into the corresponding slot (or associated with the corresponding slot),” the expression “corresponds to the protocol stack corresponding to the corresponding slot,” and the expression “corresponds to the RF path corresponding to the corresponding protocol stack” may be interchangeably used. The electronic device 101 may perform communication associated with the first protocol stack 511 (or associated with the first SIM 111) using, e.g., a first RF path corresponding to the first protocol stack 511. Here, the first RF path may include, e.g., at least one piece of hardware for generating and/or processing (e.g., amplifying and/or changing a path) a signal (e.g., a baseband signal, an IF signal, and/or an RF signal, but not limited thereto) based on the first protocol stack 511. For example, the first RF path may include a first antenna 543 and a first RF circuit 541. The first RF circuit 541 may include, as at least one piece of hardware for reception, e.g., a low noise amplifier for amplifying an RF signal output from the first antenna 543, an RFIC (or a part thereof) for converting the amplified RF signal into a baseband signal, and/or a switch for path connection, but is not limited thereto. The first RF circuit 541 may include, as at least one piece of hardware for transmission, an RFIC (or a part thereof) for converting a baseband signal into an RF signal, a power amplifier for amplifying an RF signal, and/or a switch for path connection, but is not limited thereto. The second protocol stack 512 corresponding to the second SIM 112 (or corresponding to a slot corresponding to the second SIM 112 or corresponding to the second RF path) may include a GMC layer 531, an RRM layer 532, and/or an L1 layer 533. The GMC layers 521 and 531 may indicate, trigger, and/or perform, e.g., a public land mobile network (PLMN) and/or cell selection to a lower layer, but are not limited thereto. As is described below, at least part of the GMC layers 521 and 531 may collect a list of searched cells and/or select a cell from the collected list, but there is no limitation on an entity to perform the same. For example, the GMC layers 521 and 531 may identify whether it is currently in a service state (or also referred to as in-service) or a service-unavailable state (or also referred to as out-of-service). For example, the GMC layers 521 and 531 may identify whether a scan for a cell search is required when a service is unavailable, and may trigger (or indicate a cell search to a lower layer (e.g., the RRM layers 522 and 532, but not limited thereto) when a scan is required. For example, the GMC layers 521 and 531 may identify a cell search scheme. For example, the GMC layers 521 and 531 may perform a follow-up operation (e.g., performing the search according to the determined interval and/or selecting the RAT for the follow-up search) when cell identification according to the cell search fails. For example, the GMC layers 521 and 531 may identify a cell list (e.g., referable to as an available cell list, but is not limited thereto, and may include an available cell and/or a suitable cell) and/or may select a cell from the cell list. The second RF path may include, e.g., at least one piece of hardware for generating and/or processing (e.g., amplifying and/or changing a path) a signal (e.g., a baseband signal, an IF signal, and/or an RF signal, but is not limited thereto) based on the second protocol stack 512. The RRM layers 522 and 532 may, e.g., manage radio resources, but are not limited thereto. The L1 layers 523 and 533 may be, e.g., physical layers, but are not limited thereto. The first RF path and the second RF path may be at least partially different, and accordingly, the electronic device 101 may perform first communication associated with the first SIM 111 (or the first protocol stack 511) based on the first RF path, and may perform second communication associated with the second SIM 112 (or the second protocol stack 512) based on the second RF path. For example, the electronic device 101 is a device supporting the DSDA mode, and at least part of the first communication and at least part of the second communication may be simultaneously performed.

For example, the electronic device 101 may perform first communication associated with the first SIM 111 (or the first protocol stack 511) based on the first RF path, and may perform second communication associated with the second SIM 112 (or the second protocol stack 512) based on the second RF path, and may identify failure in the first communication and the second communication. Alternatively, the electronic device 101 may be configured to perform only the first communication associated with the first SIM 111 (or the first protocol stack 511), and then perform subsequent operations according to the failure in the first communication. Alternatively, the electronic device 101 may be configured to perform only the second communication associated with the second SIM 112 (or the second protocol stack 512), and then perform subsequent operations according to the failure in the second communication.

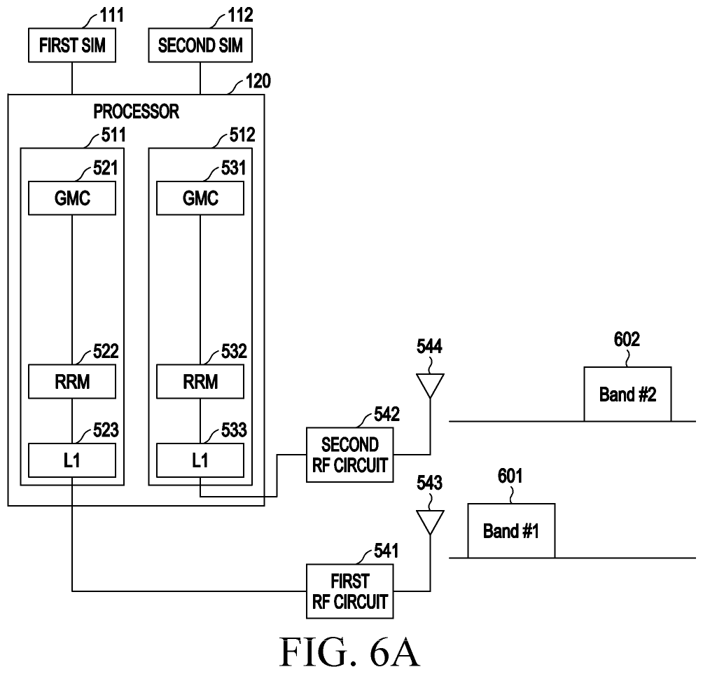

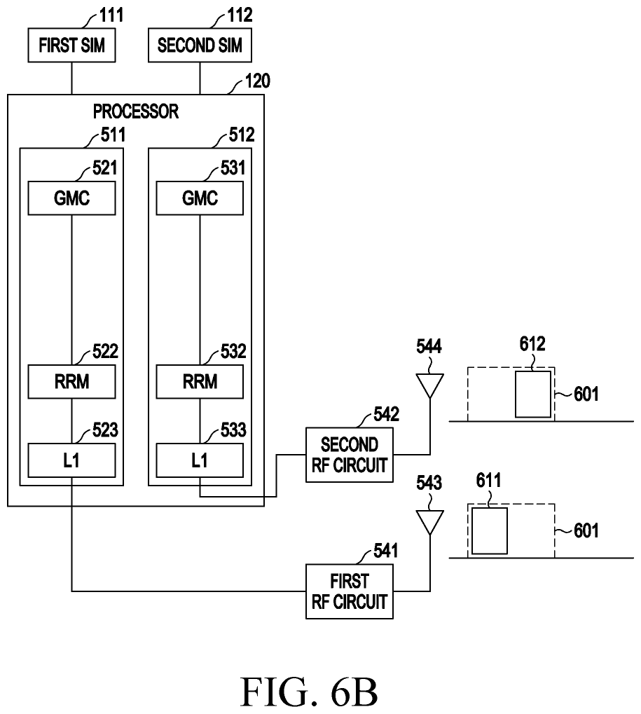

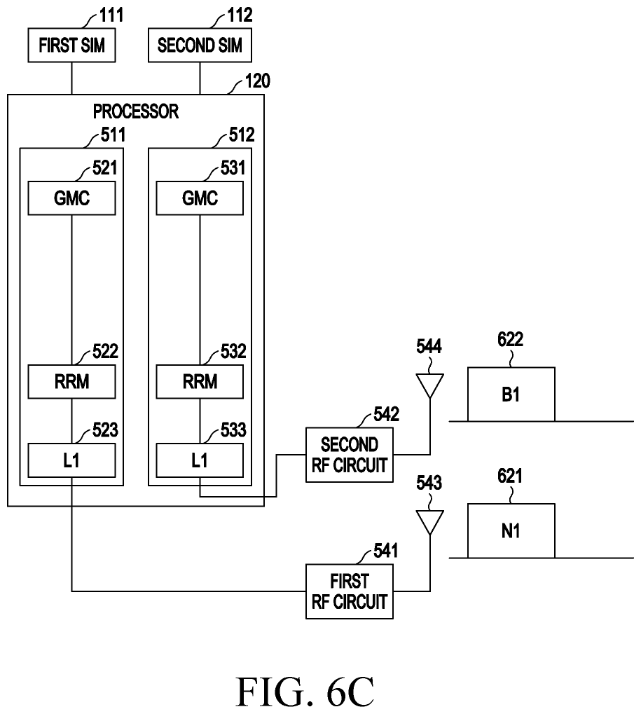

According to an embodiment, in operation 503, based on identification of the failure in the first communication and the failure in the second communication, the electronic device 101 may perform at least one first scan for at least a portion of a first part of a plurality of frequencies for non-terrestrial network communication supported by the electronic device 101 using a first RF path corresponding to the first SIM 111 (or the first protocol stack 511), and may perform at least one second scan for at least a portion of a second part different from the first part of the plurality of frequencies for non-terrestrial network communication supported by the electronic device 101 using a second RF path corresponding to the second SIM 112 (or the second protocol stack 512). Meanwhile, according to implementation, the electronic device 101 may perform a scan for terrestrial network communication after identifying the failure in communication, and may perform operation 503 as the terrestrial network cell is not detected as a result of the scan, but implementation thereof is not limited thereto. Various examples of scanning based on both RF paths of the first part and the second part are described with reference to FIGS. 6A to 6C. For example, the electronic device 101 may determine to perform full-scan on the non-terrestrial network, and accordingly, as in operation 503, the electronic device 101 may perform a scan on the first part using the first RF path and scan on the second part using the second RF path. For example, the electronic device 101 may determine to perform full-scan on the non-terrestrial network based on identification of failure in the first communication and failure in the second communication and satisfaction of an additional condition. For example, when cell detection fails according to the result of performing the scan for the terrestrial network (e.g., the scan based on the stored information and/or the full-scan for the terrestrial network), which is an example of the additional condition, the electronic device 101 may determine to perform the scan for the non-terrestrial network. In this case, the electronic device 101 may perform a scan based on the stored information about the non-terrestrial network. The electronic device 101 may determine to perform the full-scan on the non-terrestrial network when the cell detection according to the scan on the non-terrestrial network (or stored scan) based on the stored information, fails, which is an example of the additional condition. Alternatively, when cell detection according to a terrestrial network scan fails, which is an example of the additional condition, the electronic device 101 may immediately determine to perform a full-scan on the non-terrestrial network. It will be appreciated by one of ordinary skill in the art that the above-described additional conditions for full-scan on non-terrestrial networks may be applied not only to the embodiment but also to other embodiments. In the case of the terrestrial network, the supported operating bands may be different for each of the SIMs 111 and 112 (or for each operator corresponding to each of the SIMs 111 and 112). However, the number of the type of operating band corresponding to the non-terrestrial network is relatively small, and accordingly, it is relatively likely that different operators support the same (or partially different) operating band. For example, in the case of an operating band for a non-terrestrial network, the operating bands of the S-band and the Ka-Band are applied based on the 3GPP standardization organization standard TS38.821, and the number of the types are relatively small compared to the various bands of the terrestrial network. Accordingly, when a scan is performed for each SIM, it may be highly likely to perform duplicate band searches. If the independent full-scan of the non-terrestrial network is performed based on the first SIM 111 (or the first protocol stack) and the independent full-scan of the non-terrestrial network is performed based on the second SIM 112 (or the second protocol stack), there is a possibility that the scans for the same frequency may be duplicated, which may cause a delay in the performance of the non-terrestrial network communication service. For example, the operators corresponding to both the SIMS 111 and 112 are highly likely to assign the same operating band for non-terrestrial communication. In this case, despite the same operating band, the electronic device 101 may scan the frequencies included in the corresponding operating band using the first RF path corresponding to the first SIM 111, and may scan the frequencies included in the corresponding operating band using the second RF path corresponding to the second SIM 112. Accordingly, there is a possibility that duplicate scanning may be performed on the frequencies included in one operating band. Among the non-terrestrial network communication services, there may be a service (e.g., an emergency call) required in an emergency, which may cause a serious service delay. Accordingly, when the use of the non-terrestrial network is required (e.g., in an emergency), the electronic device 101 may divide a plurality of frequencies for the non-terrestrial network communication and scan the divided frequencies using different RF paths (e.g., a first RF path corresponding to the first SIM 111 and a second RF path corresponding to the second SIM 112), thereby reducing the possibility of delay in performing the non-terrestrial network communication service.

Although not illustrated, when a cell is detected according to a scan result, the electronic device 101 may perform at least one operation for accessing the detected cell. The cell may be a suitable cell and/or an acceptable cell, but is not limited. If the cell is not detected according to the scan result, the electronic device 101 may continue the split scan of the frequencies for full-scan on the non-terrestrial network, may perform the scan on the terrestrial network, or may perform the scan based on the stored information about the non-terrestrial network, but is not limited thereto.

FIG. 5C is a flowchart illustrating an operation method of an electronic device according to an embodiment of the disclosure.

According to an embodiment, in operation 581, an electronic device 101 may perform a first scan on a first part of a plurality of frequencies for non-terrestrial network communication using a first RF path corresponding to the first SIM 111. In operation 583, while the first scan is performed, the electronic device 101 may perform the second scan on the second part of the plurality of frequencies for non-terrestrial network communication using the second RF path corresponding to the second SIM 112. Here, the second part may include, at least, frequencies different from the first part. As described above, as the second scan using the second RF path is performed while the first scan using the first RF path is performed, a scan for relatively fast non-terrestrial network communication may be performed, and duplicate scan for one frequency may be prevented. In operation 585, the electronic device 101 may perform at least one operation for accessing the cell identified by the second scan using the first SIM 111. For example, the electronic device 101 may identify the cell based on the second scan. When it is identified that the cell identified based on the second scan is associated with the first SIM 111, the electronic device 101 may perform at least one operation for accessing the cell identified by the second scan using the first SIM I11.

FIG. 6A is a view illustrating a frequency scan according to an embodiment of the disclosure.

Referring to FIG. 6A, according to an embodiment, it is assumed that an electronic device 101 supports a first operating band Band #1 601 and a second operating band Band #2 602 for non-terrestrial network communication. The electronic device 101 may perform at least one scan on the first operating band Band #1 601 using a first RF path (which may be, e.g., at least a portion of the first RF circuit 541 and the first antenna 543, but not limited thereto) corresponding to the first SIM 111. The electronic device 101 may perform at least one scan on the second operating band Band #2 602 using a second RF path (which may be, e.g., at least a portion of a second RF circuit 542 and a second antenna 544, but not limited thereto) corresponding to the second SIM 112. Some of the at least one scan for the first operating band Band #1 601 and some of the at least one scan for the second operating band Band #2 602 may be performed substantially simultaneously, but are not limited thereto.

For example, the first operating band Band #1 601 may be an N1 operating band of new radio (NR), and the downlink of the N1 operating band may be 2110 to 2170 megahertz (MHz). The electronic device 101 may scan frequencies included in 2110 to 2170 MHz using, e.g., the first RF path corresponding to the first SIM 111 (which may be, e.g., at least a portion of the first RF circuit 541 and the first antenna 543, but is not limited thereto). The second operating band Band #2 602 may be an N256 operating band of NR, and the downlink of the N256 operating band may be 2170 to 2200 MHz. As described above, e.g., scans may be performed on each of the operating bands having different operating band identification numbers for the same RAT. The electronic device 101 may scan frequencies included in 2170 MHz to 2200 MHz using, e.g., the second RF path corresponding to the second SIM 112 (which may be, e.g., at least a portion of the second RF circuit 542 and the second antenna 544 but not limited thereto). Meanwhile, this is exemplary, and for example, scans may be performed on each of the operating bands having different operating band identification numbers of different RATs.

If the embodiment is not applied, for a full-scan on the non-terrestrial network, the electronic device 101 may perform a scan on the frequencies included in the first operating band Band #1 601 and the second operating band Band #2 602, e.g., 2110 MHz 2170 MHz and 2170 MHz to 2200 MHz, using the first RF path based on the first SIM, and perform a scan on the frequencies included in the first operating band Band #1 601 and the second operating band Band #2 602, e.g., 2110 MHz to 2170 MHZ and 2170 MHz to 2200 MHz, using the second RF path based on the second SIM, so that the scans may be performed on the first SIM and the second SIM, respectively, with duplication in a some frequency section (e.g., 2110 MHz to 2200 MHz band), causing the likelihood of a delay in non-terrestrial network communication connection. In contrast, the electronic device 101 according to an embodiment may perform a scan on frequencies included in the first operating band Band #1 601, e.g., 2110 to 2170 MHz, using the first RF path, and may perform a scan on frequencies included in the second operating band Band #2 602, e.g., 2170 to 2200 MHZ, using the second RF path, thereby preventing duplicate scanning and reducing the time required until the full-scan is completed.

For example, the period during which at least one scan for the first operating band Band #1 601 is performed may be at least partially the same as the period during which at least one scan for the second operating band Band #2 602 is performed. For example, the period during which at least one scan for the first operating band Band #1 601 is performed may include the period during which at least one scan for the second operating band Band #2 602 is performed. For example, the period during which at least one scan for the second operating band Band #2 602 is performed may include the period during which at least one scan for the first operating band Band #1 601 is performed. For example, a portion of the period during which at least one scan for the first operating band Band #1 601 is performed may overlap a portion of the period during which at least one scan for the second operating band Band #2 602 is performed. For example, the period of at least one scan for the first operating band Band #1 601 and the period of at least one scan for the second operating band Band #2 602 may be included together within a predetermined time unit. In this case, even if the period of at least one scan for the first operating band Band #1 601 and the period of at least one scan for the second operating band Band #2 602 do not physically overlap each other, it may be expressed that at least one scan for the first operating band Band #1 601 and at least one scan for the second operating band Band #2 602 may be performed simultaneously, and those skilled in the art will understand that this may be applied not only to the embodiment but also to “simultaneous performance” in another embodiment. Meanwhile, as described above, the division to equal sizes (e.g., one operating band each) is merely an example, and more frequencies than other RF paths may be allocated to the RF path corresponding to a specific SIM, which may be applied not only to the embodiment but also to other embodiments. Meanwhile, the electronic device 101 may pre-store information about the frequency at which the scan is to be performed for each RF path (or for each SIM, slot, or protocol stack), and may perform the scan using the information stored during the full-scan. The stored information may not be changed, but may be changed in some cases. Alternatively, the electronic device 101 may be configured to divide frequencies at the scan time, and is not limited thereto.

FIG. 6B is a view illustrating a frequency scan according to an embodiment of the disclosure.

Referring to FIG. 6B, according to an embodiment, it is assumed that an electronic device 101 supports a first operating band Band #1 601 for non-terrestrial network communication. The electronic device 101 may perform at least one scan on a first part 611 of the first operating band Band #1 601 using a first RF path (which may be, e.g., at least a portion of the first RF circuit 541 and the first antenna 543, but not limited thereto) corresponding to the first SIM 111. The electronic device 101 may perform at least one scan on a second part 612 of the first operating band Band #1 601 using a second RF path (which may be, e.g., at least a portion of the second RF circuit 542 and the second antenna 544, but not limited thereto) corresponding to the second SIM 112.

Some of the at least one scan for the first part 611 of the first operating band Band #1 601 and some of the at least one scan for the second part 612 of the first operating band Band #1 601 may be performed substantially simultaneously, but are not limited thereto.

For example, the first operating band Band #1 601 may be the N1 operating band of NR. The electronic device 101 may scan frequencies included in 2110 to 2140 MHz which are the first part 611 of 2110 to 2170 MHz using, e.g., the first RF path corresponding to the first SIM 111 (which may be, e.g., at least a portion of the first RF circuit 541 and the first antenna 543, but is not limited thereto). The electronic device 101 may scan frequencies included in 2141 to 2170 MHz which are the second part 612 of 2170 MHz to 2170 MHz using, e.g., the second RF path corresponding to the second SIM 112 (which may be, e.g., at least a portion of the second RF circuit 542 and the second antenna 544 but not limited thereto).

If the embodiment is not applied, for a full-scan on the non-terrestrial network, the electronic device 101 may perform a scan on frequencies included in the first operating band Band #1 601, e.g., 2110 to 2170 MHz, using the first RF path, and may perform a scan on frequencies included in the first operating band Band #1 601, e.g., 2110 to 2170 MHz, using the second RF path, so that duplicate scanning may be performed on some frequencies, which may cause a delay in non-terrestrial network communication connection. In contrast, the electronic device 101 according to an embodiment may perform a scan on frequencies included in the first part 611 of the first operating band Band #1 601, e.g., 2110 to 2140 MHz, using the first RF path, and may perform a scan on frequencies included in the second part 612 of the first operating band Band #1 601, e.g., 2141 to 2170 MHz, using the second RF path, thereby preventing duplicate scanning and reducing the time required until the full-scan is completed.

FIG. 6C is a view illustrating a frequency scan according to an embodiment of the disclosure.

Referring to FIG. 6C, according to an embodiment, it is assumed that an electronic device 101 supports operating bands based on different RATs based on the same frequency range. For example, it is assumed that the electronic device 101 supports, e.g., an N1 operating band 621 of NR and a B1 operating band 622 of evolved universal terrestrial radio access (E-UTRA) (or LTE) for non-terrestrial network communication. The electronic device 101 may perform at least one scan on the N1 operating band 621 using a first RF path (which may be, e.g., at least a portion of the first RF circuit 541 and the first antenna 543, but not limited thereto) corresponding to the first SIM 111. The electronic device 101 may perform at least one scan on the B1 operating band 622 using a second RF path (which may be, e.g., at least a portion of the second RF circuit 542 and the second antenna 544, but not limited thereto) corresponding to the second SIM 112. Some of the at least one scan for the N1 operating band 621 and some of the at least one scan for the B1 operating band 622 may be performed substantially simultaneously, but are not limited thereto.

For example, the frequency range of downlink in the N1 operating band 621 and B1 operating band 622 may be 2110 to 2170 MHz. For example, as described above, e.g., scans may be performed on each of the operating bands having the same operating band identification numbers for different RATs. The electronic device 101 may scan, based on NR, frequencies included in 2110 to 2170 MHz using, e.g., the first RF path corresponding to the first SIM 111 (which may be, e.g., at least a portion of the first RF circuit 541 and the first antenna 543, but is not limited thereto). The electronic device 101 may scan, based on E-UTRA, frequencies included in 2110 MHz to 2170 MHz using, e.g., the second RF path corresponding to the second SIM 112 (which may be, e.g., at least a portion of the second RF circuit 542 and the second antenna 544 but not limited thereto).

If the embodiment is not applied, for a full-scan on the non-terrestrial network, the electronic device 101 may perform an NR-based scan on frequencies included in, e.g., 2110 to 2170 MHz, using the first RF path and an E-UTRA-based scan on frequencies included in, e.g., 2110 to 2170 MHz, using the second RF path, and perform an NR-based scan on the frequencies included in, e.g., 2110 to 2170 MHZ and an E-UTRA-based scan on the frequencies included in 2110 to 2170 MHz using the second RF path, so that duplicate scanning may be performed on some frequencies, which may cause a delay in non-terrestrial network communication connection. In contrast, the electronic device 101 according to an embodiment may perform an NR-based scan on frequencies included in, e.g., 2110 to 2170 MHz, using the first RF path, and may perform an E-UTRA-based scan on frequencies included in, e.g., 2110 to 2170 MHz, using the second RF path, thereby preventing duplicate scanning and reducing the time required until the full-scan is completed. As described above, split scanning for operating bands with the same frequency range but different RATs may also be possible.

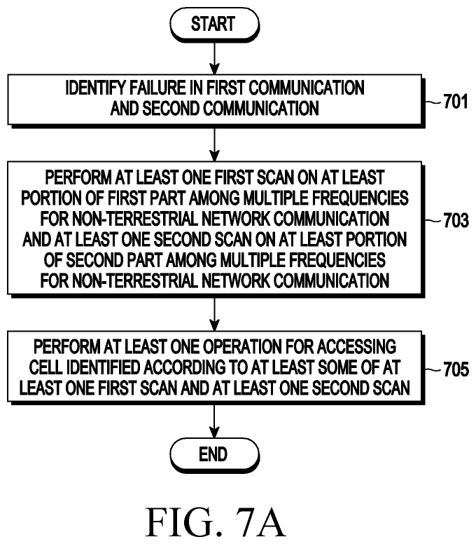

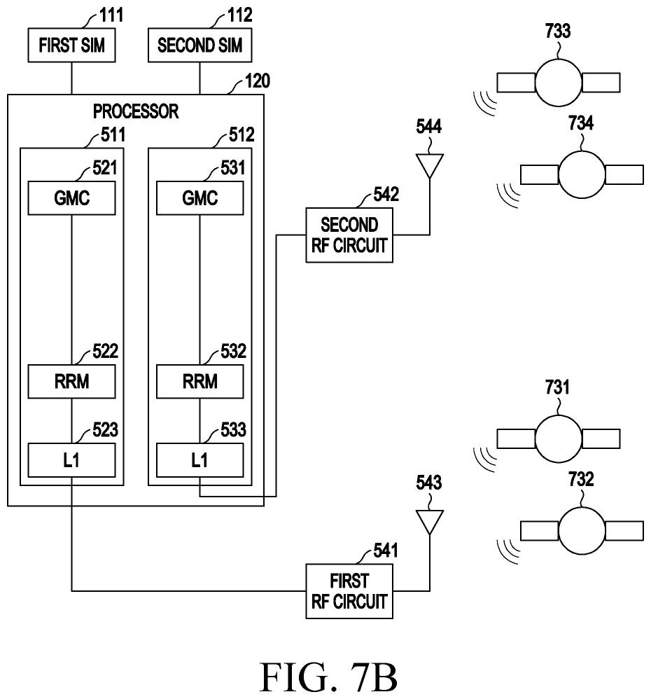

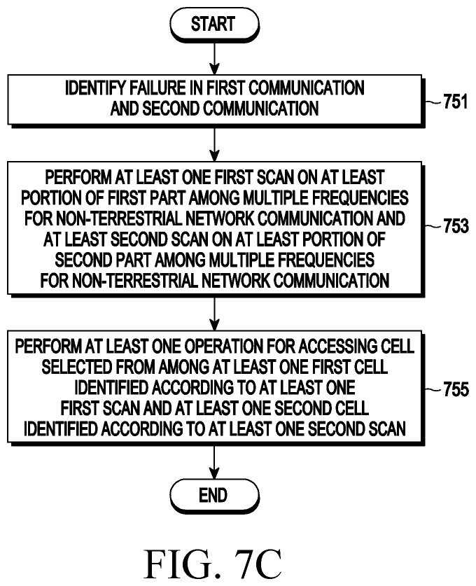

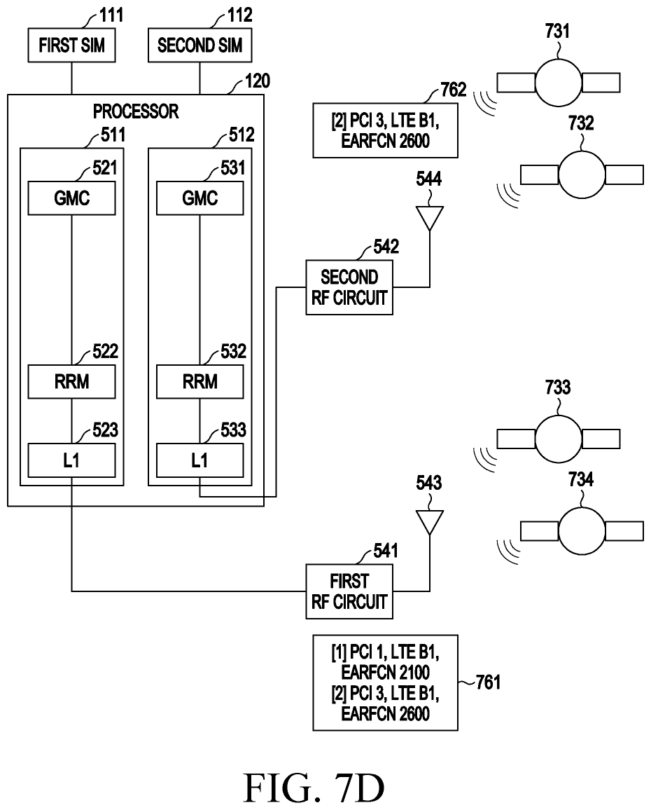

FIG. 7A is a flowchart illustrating an operation method of an electronic device according to an embodiment of the disclosure. The embodiment of FIG. 7A is described with reference to FIG. 7B. FIG. 7B is a view illustrating access according to an embodiment of the disclosure.

Referring to FIGS. 7A and 7B, according to an embodiment, in operation 701, an electronic device 101 (e.g., processor 120) may identify a failure in first communication corresponding to the first protocol stack 511 and a failure in second communication corresponding to the second protocol stack 512. In operation 703, the electronic device 101 may perform at least one first scan for at least a portion of a first part of a plurality of frequencies for non-terrestrial network communication supported by the electronic device 101 using a first RF path corresponding to the first SIM 111 (or the first protocol stack 511), based on identification of the failure in the first communication and the failure in the second communication, and may perform at least one second scan for at least a portion of a second part different from the first part of the plurality of frequencies for non-terrestrial network communication supported by the electronic device 101 using a second RF path corresponding to the second SIM 112 (or the second protocol stack 512). For example, the electronic device 101 may perform a scan for non-terrestrial network communication based on identifying communication failures before performing operation 703. When a non-terrestrial network cell is not detected as a result of scan for non-terrestrial network communication, the electronic device 101 may perform operation 703, but this is an example, and the disclosure is not limited thereto. In operation 705, the electronic device 101 may perform at least one operation for accessing at least one first cell identified according to at least one first scan and a cell identified according to at least some of at least one second scan. For example, the electronic device 101 may perform a procedure for camping on the identified cell, a random access (RA) procedure, a connection establishment (e.g., RRC connection establishment) procedure, and/or a procedure for attaching (or registering) to the core network, as the at least one operation for accessing the identified cell, but is not limited thereto.

For example, the electronic device 101 may identify a cell that meets a cell selection criterion according to at least a portion of at least one first scan for at least a portion of a first part of a plurality of frequencies and at least one second scan for at least a portion of a second part of the plurality of frequencies. The electronic device 101 may perform at least one operation for accessing the cell based on identifying the cell meeting the cell selection criterion. For example, referring to FIG. 7B, it is assumed that signals from a first NTN cell 731, a second NTN cell 732, a third NTN cell 733, and a fourth NTN cell 734 may be measured by the electronic device 101. For example, the electronic device 101 may perform the first scan on the first part of the plurality of frequencies based on the first RF path (which may be, e.g., at least a portion of the first RF circuit 541 and the first antenna 543, but is not limited thereto), and may perform the second scan on the second part of the plurality of frequencies based on the second RF path (which may be, e.g., at least a portion of the second RF circuit 542 and the second antenna 544, but is not limited thereto). When a suitable cell is identified while performing the first scan and the second scan, the electronic device 101 may stop performing, e.g., an additional scan and may perform at least one operation for accessing the identified cell. For example, it is assumed that the electronic device 101 identifies that the first NTN cell 731 meets the cell selection criterion using the first RF path. The electronic device 101 may stop the additional scan using the first RF path and the additional scan using the second RF path, and may perform at least one operation for accessing the first NTN cell 731. For example, if it is identified that communication with the first NTN cell 731 may be performed based on the first SIM 111, the electronic device 101 may perform at least one operation for accessing the first NTN cell 731 based on the first SIM 111 (or the first protocol stack 511) using the first RF path. For example, if it is identified that communication with the first NTN cell 731 may be performed based on the second SIM 112, the electronic device 101 may perform at least one operation for accessing the first NTN cell 731 based on the second SIM 112 (or the second protocol stack 512) using the second RF path.

FIG. 7C is a flowchart illustrating an operation method of an electronic device according to an embodiment of the disclosure. The embodiment of FIG. 7C is described with reference to FIG. 7D. FIG. 7D is a view illustrating access according to an embodiment of the disclosure.

Referring to FIGS. 7C and 7D, according to an embodiment, in operation 751, an electronic device 101 (e.g., the processor 120) may identify a failure in first communication corresponding to the first protocol stack 511 and a failure in second communication corresponding to the second protocol stack 512. In operation 753, the electronic device 101 may perform at least one first scan for at least a portion of a first part of a plurality of frequencies for non-terrestrial network communication supported by the electronic device 101 using a first RF path corresponding to the first SIM 111 (or the first protocol stack 511), based on identification of the failure in the first communication and the failure in the second communication, and may perform at least one second scan for at least a portion of a second part different from the first part of the plurality of frequencies for non-terrestrial network communication supported by the electronic device 101 using a second RF path corresponding to the second SIM 112 (or the second protocol stack 512). In operation 755, the electronic device 101 may perform at least one operation for accessing a cell selected from among at least one first cell identified according to at least one first scan and at least one second cell identified according to at least one second scan. For example, referring to FIG. 7D, the electronic device 101 may identify a first cell list 761 according to at least one first scan and may identify a second cell list 762 according to at least one second scan. The cell lists 761 and 762 may include, e.g., a PLMN, a physical cell identity (PCI), a reception strength, an operating band, and/or frequency information (e.g., an absolute radio frequency channel number (ARFCN)) (e.g., E-UTRA ARFCN (EARFCN)), but are not limited thereto. The electronic device 101 may select one cell from the cell lists 761 and 762. For example, the electronic device 101 may select the cell based on the priority of the public land mobile network (PLMN). For example, the electronic device 101 may select a cell associated with the PLMN corresponding to the R-PLMN from among the identified cells. If the cell associated with the PLMN corresponding to the R-PLMN is not identified, the cell associated with the next-priority PLMN may be selected. For example, the electronic device 101 may select any one of the cells based on the reception strength of the signal (e.g., the synchronization signal) from the cell. For example, if a plurality of cells are identified for the same PLMN, the electronic device 101 may select a cell corresponding to a relatively greater reception strength. Alternatively, the electronic device 101 may be implemented to select a cell having the highest reception strength without considering the PLMN, and the method of selecting the cell is not limited.

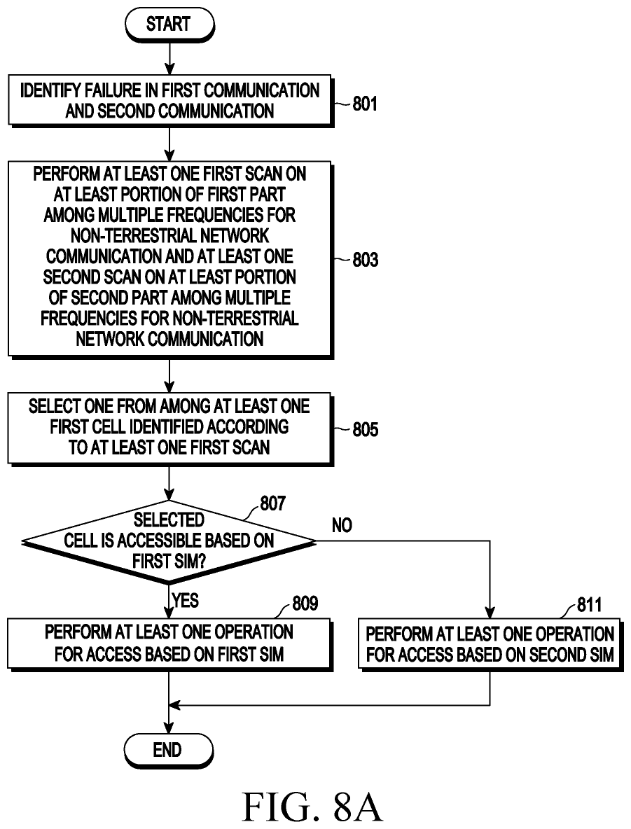

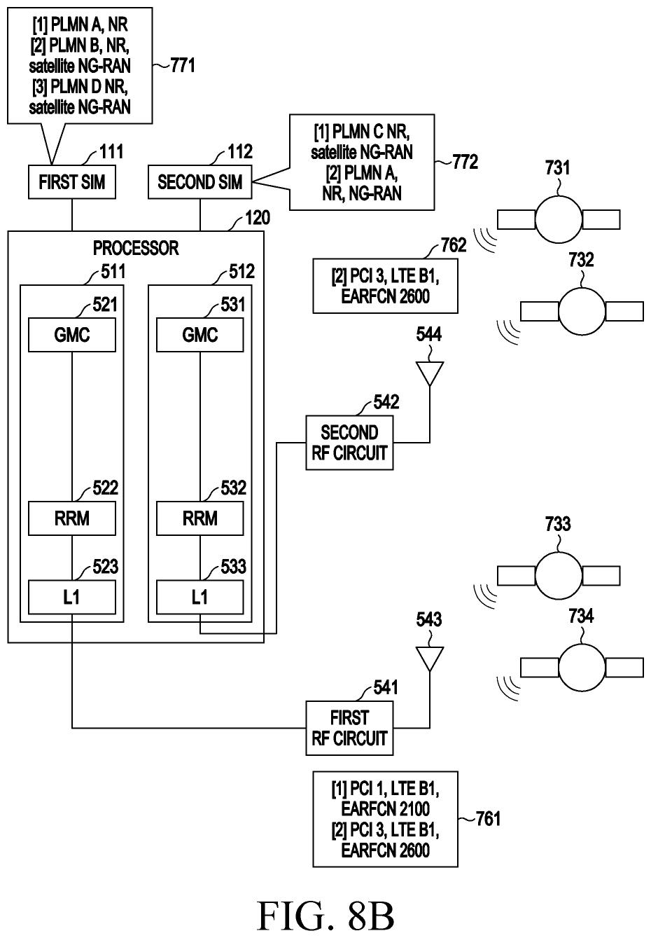

FIG. 8A is a flowchart illustrating an operation method of an electronic device according to an embodiment of the disclosure. The embodiment of FIG. 8A is described with reference to FIG. 8B. FIG. 8B is a view illustrating access according to an embodiment of the disclosure.

Referring to FIGS. 8A and 8B, according to an embodiment, in operation 801, an electronic device 101 (e.g., processor 120) may identify a failure in first communication corresponding to the first protocol stack 511 and a failure in second communication corresponding to the second protocol stack 512. In operation 803, the electronic device 101 may perform at least one first scan for at least a portion of a first part of a plurality of frequencies for non-terrestrial network communication supported by the electronic device 101 using a first RF path corresponding to the first SIM 111 (or the first protocol stack 511), based on identification of the failure in the first communication and the failure in the second communication, and may perform at least one second scan for at least a portion of a second part different from the first part of the plurality of frequencies for non-terrestrial network communication supported by the electronic device 101 using a second RF path corresponding to the second SIM 112 (or the second protocol stack 512). In operation 805, the electronic device 101 may select one of the at least one first cell identified according to the at least one first scan. For example, the electronic device 101 may select one of at least one first cell identified according to at least one first scan and at least one second cell identified according to at least one second scan. Alternatively, e.g., the electronic device 101 may fail to detect a cell according to at least one second scan, and may select one of at least one first cell identified according to at least one first scan.

According to an embodiment, in operation 807, the electronic device 101 may identify whether the selected cell is accessible based on the first SIM 111. If it is identified that the selected cell is accessible based on the first SIM 111 (Yes in operation 807), the electronic device 101 may perform at least one operation for access based on the first SIM 111 in operation 809. If it is identified that the selected cell is accessible based on the second SIM 112 (No in operation 807), the electronic device 101 may perform at least one operation for access based on the second SIM 112 in operation 811. For example, referring to FIG. 8B, first access information 771 may be stored in the first SIM 111, and second access information 772 may be stored in the second SIM 112. For example, it is assumed that the first cell (e.g., PCI: 1) of the first cell list 761 identified using the first RF path is selected. When the PLMN corresponding to the first cell (e.g., PCI: 1) is A, the electronic device 101 may perform an operation for accessing the first cell (e.g., PCI: 1) based on the first SIM 111 as the first SIM 111 supports the PLMN A. For example, the electronic device 101 may perform an operation for accessing the first cell (e.g., PCI: 1) based on the first SIM 111 using the first RF path. When the PLMN corresponding to the first cell (e.g., PCI: 1) is C, the electronic device 101 may perform an operation for accessing the first cell (e.g., PCI: 1) based on the second SIM 112 as the first SIM 111 does not support PLMN A and the second SIM 112 supports PLMN B. For example, the electronic device 101 may perform an operation for accessing the first cell (e.g., PCI: 1) based on the second SIM 112 using the second RF path.

Meanwhile, similar to the above description, when one of the at least one second cell identified according to the at least one second scan is selected, the electronic device 101 may identify whether the selected cell is accessible based on the second SIM 112. If the selected cell is accessible based on the second SIM 112, the electronic device 101 may perform at least one operation for accessing the selected cell based on the second SIM 112. If the selected cell is not accessible based on the second SIM 112 and is accessible based on the first SIM 111, the electronic device 101 may perform at least one operation for accessing the selected cell based on the first SIM 111.

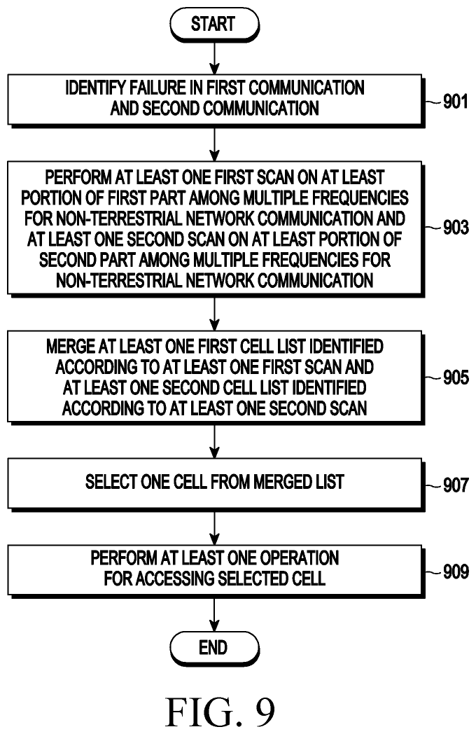

FIG. 9 is a flowchart illustrating a method for operating an electronic device according to an embodiment of the disclosure.

Referring to FIG. 9, according to an embodiment, in operation 901, an electronic device 101 (e.g., processor 120) may identify a failure in first communication corresponding to the first protocol stack 511 and a failure in second communication corresponding to the second protocol stack 512. In operation 903, the electronic device 101 may perform at least one first scan for at least a portion of a first part of a plurality of frequencies for non-terrestrial network communication supported by the electronic device 101 using a first RF path corresponding to the first SIM 111 (or the first protocol stack 511), based on identification of the failure in the first communication and the failure in the second communication, and may perform at least one second scan for at least a portion of a second part different from the first part of the plurality of frequencies for non-terrestrial network communication supported by the electronic device 101 using a second RF path corresponding to the second SIM 112 (or the second protocol stack 512). In operation 905, the electronic device 101 may merge the at least one first cell list identified according to the at least one first scan and the at least one second cell list identified according to the at least one second scan. Before the identification of the cell list for any one SIM is completed, the generation of the merge list may be postponed until the identification of the cell list for the corresponding SIM is completed, but is not limited thereto. In operation 907, the electronic device 101 may select one cell from the merged list. In operation 909, the electronic device 101 may perform at least one operation for accessing the selected cell. For example, at least some of the GMC layers 521 and 531 of the protocol stacks 511 and 512 may perform cell list merge and/or cell selection from the merged list, but there is no limitation on the entity to perform the operations.

For example, the GMC layer 521 of the first protocol stack 511 may share the first cell list 761 identified using the first RF path with the GMC layer 531 of the second protocol stack 512. The GMC layer 531 of the second protocol stack 512 may share the second cell list 762 identified using the second RF path with the GMC layer 521 of the first protocol stack 511. In this case, each of the GMC layers 521 and 531 may generate a merged list. At least some of the GMC layers 521 and 531 may select one cell from the merged list to perform (or indicate to a lower layer) a procedure for accessing the cell. For example, each of the GMC layers 521 and 531 may select cells from the selected list, and may perform a procedure for access. Alternatively, any one of the GMC layers 521 and 531 may be configured to perform an operation for accessing the cell selected from the merged list, and the remaining layers may be configured not to perform the operation for accessing the cell, but the implementation is not limited thereto. For example, any one of the GMC layers 521 and 531 may be set as a layer (which may be referred to as a master layer, for convenience) for generation of a merged list and cell selection. In this case, the master layer may receive a list from another layer to generate a merged list, and may select one cell from the merged list. Meanwhile, the GMC layers 521 and 531 are examples of entities that generate a merged list and select a cell, but the entities that perform the merged list are not limited thereto. For example, generation of the merged list and cell selection may be performed by another layer in the protocol stacks 511 and 512, or generation of the merged list and cell selection may be performed by another entity not included in the protocol stacks 511 and 512.

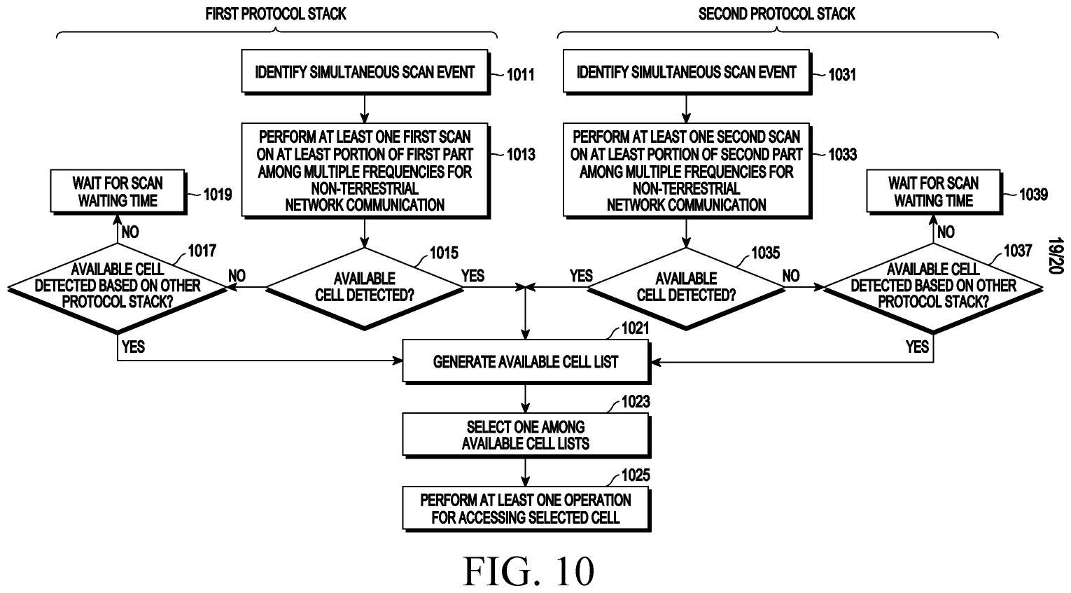

FIG. 10 is a flowchart illustrating an operation method of an electronic device according to an embodiment of the disclosure.

Referring to FIG. 10, according to an embodiment, in operation 1011, an electronic device 101 (e.g., processor 120) may identify a simultaneous scan event, based on the first protocol stack 511. Here, the simultaneous scan event may include, e.g., a communication failure for communication based on both SIMs 111 and 112, a cell detection failure according to a terrestrial network scan, and/or a cell detection failure according to a scan based on stored information about a non-terrestrial network, but is not limited thereto. In operation 1013, the electronic device 101 may perform at least one first scan on at least a portion of the first part of the plurality of frequencies for non-terrestrial network communication, based on the first protocol stack 511. The electronic device 101 may identify a simultaneous scan event based on the second protocol stack 512 in operation 1031. In operation 1033, the electronic device 101 may perform at least one second scan on at least a portion of the second part of the plurality of frequencies for non-terrestrial network communication.

According to an embodiment, in operation 1015, the electronic device 101 may identify whether an available cell (or suitable cell) is detected according to at least one first scan. If an available cell (or suitable cell) is detected (Yes in operation 1015), the electronic device 101 may generate an available cell list or may add information about the corresponding cell to the pre-generated cell list in operation 1021. If the available cell is not detected (No in operation 1015), the electronic device 101 may identify whether the available cell is detected by another protocol stack (e.g., the second protocol stack 512) in operation 1017. For example, available cells may be implemented to be shared with each other between the protocol stacks 511 and 512, and accordingly, it may be identified whether an available cell based on the second protocol stack 512 is detected based on the first protocol stack 511, but this is an example, and the disclosure is not limited thereto. If an available cell is detected by another protocol stack (e.g., the second protocol stack 512) (Yes in operation 1017), the electronic device 101 may generate an available cell list or may add information about the corresponding cell to the pre-generated cell list in operation 1021. If the available cell is not detected by another protocol stack (No in operation 1017), the electronic device 101 may wait for a scan waiting period in operation 1019. When the scan waiting period elapses, the electronic device 101 may perform a split scan on the non-terrestrial network again, or may resume the scan on the terrestrial network. In operation 1035, the electronic device 101 may identify whether an available cell (or suitable cell) is detected according to at least one second scan. If an available cell (or suitable cell) is detected (Yes in operation 1035), the electronic device 101 may generate an available cell list or may add information about the corresponding cell to the pre-generated cell list in operation 1021. If the available cell is not detected (No in operation 1035), the electronic device 101 may identify whether the available cell is detected by another protocol stack (e.g., the second protocol stack 512) in operation 1037. For example, it may be identified whether an available cell based on the first protocol stack 511 is detected based on the second protocol stack 512, but this is not limited thereto. If an available cell is detected by another protocol stack (e.g., the second protocol stack 512) (Yes in operation 1037), the electronic device 101 may generate an available cell list or may add information about the corresponding cell to the pre-generated cell list in operation 1021. If the available cell is not detected by another protocol stack (No in operation 1037), the electronic device 101 may wait for a scan waiting period in operation 1039. When the scan waiting period elapses, the electronic device 101 may perform a split scan on the non-terrestrial network again, or may resume the scan on the terrestrial network. In operation 1023, the electronic device 101 may select one of the available cell lists. In operation 1025, the electronic device 101 may perform at least one operation for accessing the selected cell. According to an embodiment, after accessing the selected cell, the electronic device 101 may update the stored cell information with the corresponding cell.

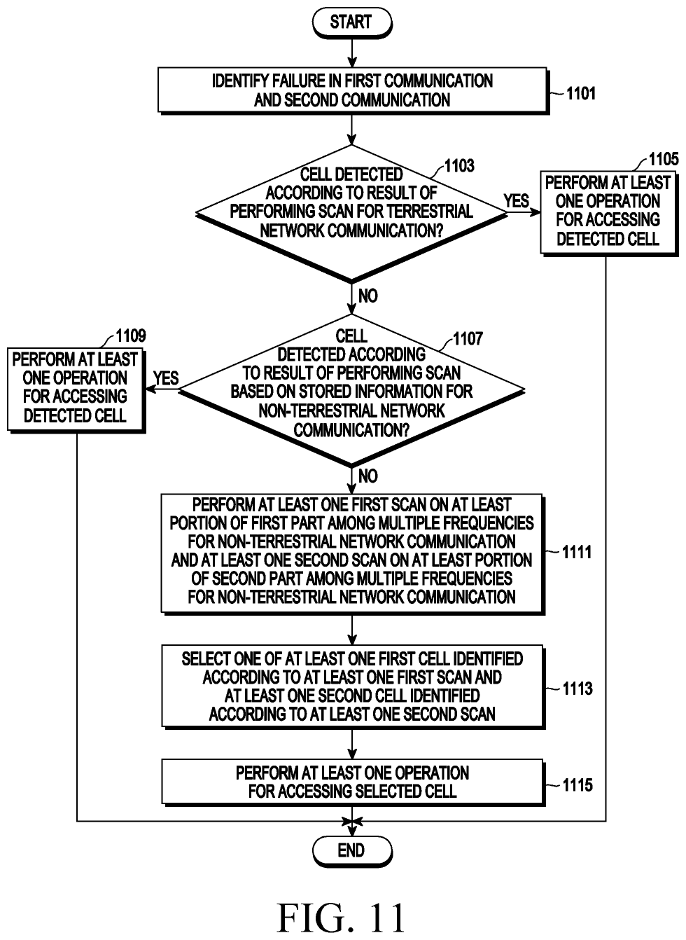

FIG. 11 is a flowchart illustrating an operation method of an electronic device according to an embodiment of the disclosure.

Referring to FIG. 11, according to an embodiment, an electronic device 101 (e.g., processor 120) may identify failure in the first communication and the second communication, in operation 1101. For example, based on the failure in the first communication and the second communication, in operation 1103, the electronic device 101 may perform a scan on the terrestrial network (e.g., a scan based on the stored information and/or a full-scan on the terrestrial network), and may identify whether a cell is detected according to the result of performing the scan for the terrestrial network communication. If the cell is detected as a result of performing the scan for the terrestrial network communication (Yes in operation 1103), the electronic device 101 may perform at least one operation for accessing the detected cell in operation 1105. If the cell is not detected as a result of performing the scan for the terrestrial network communication (No in operation 1103), the electronic device 101 may perform the scan based on the stored information for the non-terrestrial network communication and identify whether the cell is detected according to the result of performing the scan based on the stored information in operation 1107. In one example, the electronic device 101 may perform a scan using the first RF path based on the stored information based on the first protocol stack 511, and may perform a scan using the second RF path based on the stored information based on the second protocol stack 512. Alternatively, the electronic device 101 may merge the information stored based on the first protocol stack 511 and the information stored based on the second protocol stack 512, may split the information, may scan the split portion using the first RF path, and may scan the remaining portion using the second RF path, but is not limited thereto. If the cell is detected according to the result of performing the scan based on the stored information (Yes in operation 1107), the electronic device 101 may perform at least one operation for accessing the detected cell in operation 1109. If the cell is not detected according to the result of performing the scan based on the stored information (No in operation 1107), in operation 1111, as described above, the electronic device 101 may perform at least one first scan for at least a portion of the first part of the plurality of frequencies for non-terrestrial network communication using the first RF path, and may perform at least one second scan for at least a portion of the second part of the plurality of frequencies for non-terrestrial network communication using the second RF path. In operation 1113, the electronic device 101 may select one of the at least one first cell identified according to the at least one first scan and the at least one second cell identified according to the at least one second scan. In operation 1115, the electronic device 101 may perform at least one operation for accessing the selected cell. For example, when the full scan is performed on the terrestrial network, the electronic device 101 may perform the full scan associated with the first SIM 111 using the first RF path and may perform the full scan associated with the second SIM 112 using the second RF path. When the full scan is performed on the non-terrestrial network, the electronic device 101 may perform the scan on the first part of frequencies for the non-terrestrial network supported by the electronic device 101 using the first RF path and may perform the scan on the second part of frequencies for the non-terrestrial network supported by the electronic device 101 using the second RF path.

According to an embodiment, there may be provided a computer-readable storage medium storing at least one instruction. The at least one instruction may, when executed by at least one processor 120 of an electronic device 101, enable the electronic device 101 to perform at least one operation. The at least one operation may comprise performing a first scan for a first part of a plurality of frequencies for non-terrestrial networks (NTN) communication, using a first RF path of the electronic device 101 corresponding to a first SIM capable of being used by the at least one processor 120. The at least one operation may comprise, while the first scan is performed, performing a second scan for a second part of the plurality of frequencies for the NTN communication, using a second RF path of the electronic device 101 corresponding to a second SIM capable of being used by the at least one processor 120. The second part may at least comprise frequencies different from the first part. The at least one operation may comprise performing at least one operation for accessing a cell identified by the second scan, using the first SIM.

According to an embodiment, frequencies of the first part and frequencies of the second part may be different.

According to an embodiment, the first part may comprise at least one first frequency corresponding to a first operating band of a plurality of operating bands for NTN communication supported by the electronic device 101. The second part may comprise at least one second frequency corresponding to a second operating band of the plurality of operating bands for the NTN communication supported by the electronic device, wherein the second operating band is different from the first operating band.

According to an embodiment, the first operating band may comprise a first operating band identification number of a first radio access technology (RAT). The second operating band comprises a second operating band identification number of the first RAT, and the second operating band identification number is different from the first operating band identification number.

According to an embodiment, the first operating band may comprise a first operating band identification number of a first RAT. The second operating band may comprise the first operating band identification number of a second RAT different from the first RAT.

According to an embodiment, the first operating band may comprise a first operating band identification number of a first RAT. The second operating band may comprise a second operating band identification number different from the first operating band identification number of a second RAT different from the first RAT.

According to an embodiment, the first part may comprise at least one third frequency corresponding to a first range of a frequency range of a first operating band of a plurality of operating bands for NTN communication supported by the electronic device 101. The second part may comprise at least one fourth frequency corresponding to a second range, different from the first range, of the frequency range of the first operating band of the plurality of operating bands for NTN communication supported by the electronic device 101.

According to an embodiment, performing the at least operation for accessing the cell identified by the second scan, using the first SIM may comprise directly performing the at least operation for accessing the cell identified by the second scan.

According to an embodiment, the at least one operation may comprise selecting the cell identified by the second scan, based on at least one of public land mobile network (PLMN) information, RAT information, or reception strength information about at least one first cell identified according to a result of the first scan and at least one second cell identified according to a result the second scan.

According to an embodiment, performing the at least operation for accessing the cell identified by the second scan, using the first SIM may comprise performing, by using the first RF path, the at least operation for accessing the cell identified by the second scan based on the cell identified by the second scan being associated with the first SIM.

According to an embodiment, the first scan and the second scan may be performed based on failure in cell detection according to at least one fifth scan based on first stored cell information stored in association with the first SIM and at least one sixth scan based on second stored cell information stored in association with the second SIM.

According to an embodiment, an electronic device 101 may comprise memory 130 storing at least one instruction. The electronic device 101 may comprise a processor 120 connected to the memory 130. The at least one instruction may, when executed by at least one processor 120 of an electronic device 101, enable the electronic device 101 to perform at least one operation. The at least one operation may comprise performing a first scan for a first part of a plurality of frequencies for non-terrestrial networks (NTN) communication, using a first RF path of the electronic device 101 corresponding to a first SIM capable of being used by the at least one processor 120. The at least one operation may comprise, while the first scan is performed, performing a second scan for a second part of the plurality of frequencies for the NTN communication, using a second RF path of the electronic device 101 corresponding to a second SIM capable of being used by the at least one processor 120. The second part may at least comprise frequencies different from the first part. The at least one operation may comprise performing at least one operation for accessing a cell identified by the second scan, using the first SIM.

According to an embodiment, frequencies of the first part and frequencies of the second part may be different.

According to an embodiment, the first part may comprise at least one first frequency corresponding to a first operating band of a plurality of operating bands for NTN communication supported by the electronic device 101. The second part may comprise at least one second frequency corresponding to a second operating band of the plurality of operating bands for the NTN communication supported by the electronic device, wherein the second operating band is different from the first operating band.

According to an embodiment, the first operating band may comprise a first operating band identification number of a first radio access technology (RAT). The second operating band comprises a second operating band identification number of the first RAT, and the second operating band identification number is different from the first operating band identification number.

According to an embodiment, the first operating band may comprise a first operating band identification number of a first RAT. The second operating band may comprise the first operating band identification number of a second RAT different from the first RAT.

According to an embodiment, the first operating band may comprise a first operating band identification number of a first RAT. The second operating band may comprise a second operating band identification number different from the first operating band identification number of a second RAT different from the first RAT.

According to an embodiment, the first part may comprise at least one third frequency corresponding to a first range of a frequency range of a first operating band of a plurality of operating bands for NTN communication supported by the electronic device 101. The second part may comprise at least one fourth frequency corresponding to a second range, different from the first range, of the frequency range of the first operating band of the plurality of operating bands for NTN communication supported by the electronic device 101.

According to an embodiment, performing the at least operation for accessing the cell identified by the second scan, using the first SIM may comprise directly performing the at least operation for accessing the cell identified by the second scan.

According to an embodiment, the at least one operation may comprise selecting the cell identified by the second scan, based on at least one of public land mobile network (PLMN) information, RAT information, or reception strength information about at least one first cell identified according to a result of the first scan and at least one second cell identified according to a result the second scan.

According to an embodiment, performing the at least operation for accessing the cell identified by the second scan, using the first SIM may comprise performing, by using the first RF path, the at least operation for accessing the cell identified by the second scan based on the cell identified by the second scan being associated with the first SIM.

According to an embodiment, the first scan and the second scan may be performed based on failure in cell detection according to at least one fifth scan based on first stored cell information stored in association with the first SIM and at least one sixth scan based on second stored cell information stored in association with the second SIM.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. The term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. One or more non-transitory computer-readable storage media storing one or more computer programs including computer-executable instructions that, when executed by one or more processors of an electronic device individually or collectively, cause the electronic device to perform at least one operation, the at least one operation comprising:
performing, by the electronic device, a first scan for a first part of a plurality of frequencies for non-terrestrial networks (NTN) communication by using a first radio frequency (RF) path of the electronic device corresponding to a first subscriber identity module (SIM) capable of being used by the one or more processors;
while the first scan is being performed, performing, by the electronic device, a second scan for a second part of the plurality of frequencies for the NTN communication by using a second RF path of the electronic device corresponding to a second SIM capable of being used by the one or more processors, the second part at least comprising frequencies different from the first part; and
performing, by the electronic device using the first SIM, at least one operation for accessing a cell identified by the second scan.

2. The one or more non-transitory computer-readable storage media of claim 1, wherein frequencies of the first part and frequencies of the second part are different.

3. The one or more non-transitory computer-readable storage media of claim 1,
wherein the first part comprises at least one first frequency corresponding to a first operating band of a plurality of operating bands for NTN communication supported by the electronic device,
wherein the second part comprises at least one second frequency corresponding to a second operating band of the plurality of operating bands for the NTN communication supported by the electronic device, and
wherein the second operating band is different from the first operating band.

4. The one or more non-transitory computer-readable storage media of claim 3,
wherein the first operating band comprises a first operating band identification number of a first radio access technology (RAT),
wherein the second operating band comprises a second operating band identification number of the first RAT, and
wherein the second operating band identification number is different from the first operating band identification number.

5. The one or more non-transitory computer-readable storage media of claim 3,
wherein the first operating band comprises a first operating band identification number of a first radio access technology (RAT), and
wherein the second operating band comprises the first operating band identification number of a second RAT different from the first RAT.

6. The one or more non-transitory computer-readable storage media of claim 3,
wherein the first operating band comprises a first operating band identification number of a first radio access technology (RAT),
wherein the second operating band comprises a second operating band identification number of a second RAT different from the first RAT, and
wherein the second operating band identification number is different from the first operating band identification number.

7. The one or more non-transitory computer-readable storage media of claim 1,
wherein the first part comprises at least one third frequency corresponding to a first portion of a first operating band of a plurality of operating bands for NTN communication supported by the electronic device,
wherein the second part comprises at least one fourth frequency corresponding to a second portion of the first operating band of the plurality of operating bands for NTN communication supported by the electronic device, and
wherein the first portion of the first operating band is different from the second portion of the first operating band.

8. The one or more non-transitory computer-readable storage media of claim 1, wherein the performing, by the electronic device using the first SIM, of the at least one operation for accessing the cell identified by the second scan comprises:
directly performing, by the electronic device, the at least one operation for accessing the cell identified by the second scan.

9. The one or more non-transitory computer-readable storage media of claim 1, wherein the at least one operation further comprising:
selecting, by the electronic device, the cell identified by the second scan, based on at least one of public land mobile network (PLMN) information, radio access technology (RAT) information, or reception strength information about at least one first cell identified according to a result of the first scan and at least one second cell identified according to a result the second scan.

10. The one or more non-transitory computer-readable storage media of claim 1, wherein the performing, by the electronic device using the first SIM, of the at least one operation for accessing the cell identified by the second scan comprises:
performing, by the electronic device using the first RF path, the at least one operation for accessing the cell identified by the second scan based on the cell identified by the second scan being associated with the first SIM.

11. The one or more non-transitory computer-readable storage media of claim 1, wherein the first scan and the second scan are performed based on failure of detection of a cell according to at least one fifth scan based on first stored cell information stored associated with the first SIM and at least one sixth scan based on second stored cell information stored associated with the second SIM.

12. An electronic device comprising:
memory storing one or more computer programs; and
one or more processors communicatively coupled to the memory,
wherein the one or more computer programs include computer-executable instructions that, when executed by the one or more processors individually or collectively, cause the electronic device to perform at least one operation, the at least one operation comprising:
performing a first scan for a first part of a plurality of frequencies for non-terrestrial networks (NTN) communication by using a first radio frequency (RF) path of the electronic device corresponding to a first subscriber identity module (SIM) capable of being used by the one or more processors,
while the first scan is being performed, performing a second scan for a second part of the plurality of frequencies for the NTN communication by using a second RF path of the electronic device corresponding to a second SIM capable of being used by the one or more processors, the second part at least comprising frequencies different from the first part, and
performing, by using the first SIM, at least one operation for accessing a cell identified by the second scan.

13. The electronic device of claim 12, wherein frequencies of the first part and frequencies of the second part are different.

14. The electronic device of claim 12,
wherein the first part comprises at least one first frequency corresponding to a first operating band of a plurality of operating bands for NTN communication supported by the electronic device,
wherein the second part comprises at least one second frequency corresponding to a second operating band of the plurality of operating bands for the NTN communication supported by the electronic device, and
wherein the second operating band is different from the first operating band.

15. The electronic device of claim 14,
wherein the first operating band comprises a first operating band identification number of a first radio access technology (RAT),
wherein the second operating band comprises a second operating band identification number of the first RAT, and
wherein the second operating band identification number is different from the first operating band identification number.

16. The electronic device of claim 14,
wherein the first operating band comprises a first operating band identification number of a first radio access technology (RAT), and
wherein the second operating band comprises the first operating band identification number of a second RAT different from the first RAT.

17. The electronic device of claim 14,
wherein the first operating band comprises a first operating band identification number of a first radio access technology (RAT), and
wherein the second operating band comprises a second operating band identification number different from the first operating band identification number of a second RAT different from the first RAT.

18. The electronic device of claim 12,
wherein the first part comprises at least one third frequency corresponding to a first range of a frequency range of a first operating band of a plurality of operating bands for NTN communication supported by the electronic device, and
wherein the second part comprises at least one fourth frequency corresponding to a second range, different from the first range, of the frequency range of the first operating band of the plurality of operating bands for NTN communication supported by the electronic device.

19. The electronic device of claim 12, wherein the performing, by using the first SIM, of the at least one operation for accessing the cell identified by the second scan comprises directly performing the at least one operation for accessing the cell identified by the second scan.

20. The electronic device of claim 12, wherein the at least one operation further comprising:
selecting the cell identified by the second scan based on at least one of public land mobile network (PLMN) information, radio access technology RAT information, or reception strength information about at least one first cell identified according to a result of the first scan and at least one second cell identified according to a result the second scan.

21. The electronic device of claim 12,
wherein the first RF path includes a first antenna and a first RF circuit for generating and processing a first signal based on a first protocol stack, and
wherein the second RF path includes a second antenna and a second RF circuit for generating and processing a second signal based on a second protocol stack.

22. The electronic device of claim 21,
wherein the first protocol stack includes a first global mode control (GMC) layer, a first radio resource management (RRM) layer, and a first L1 layer, and
wherein the second protocol stack includes a second GMC layer, a second RRM layer, and a second L1 layer.

23. A method performed by an electronic device, the method comprising:
performing, by the electronic device, a first scan for a first part of a plurality of frequencies for non-terrestrial networks (NTN) communication by using a first radio frequency (RF) path of the electronic device corresponding to a first subscriber identity module (SIM) capable of being used by one or more processors of the electronic device;
while the first scan is being performed, performing, by the electronic device, a second scan for a second part of the plurality of frequencies for the NTN communication by using a second RF path of the electronic device corresponding to a second SIM capable of being used by the one or more processors, the second part at least comprising frequencies different from the first part; and
performing, by the electronic device using the first SIM, at least one operation for accessing a cell identified by the second scan.
